(19) United States
(12) Patent Application Publication
(10) Pub. No.: US 2014/0076099 A1
(43) Pub. Date: Mar. 20, 2014

(54) ENERGY STORAGE SYSTEM

(71) Applicant: Gary Murphy, Widnes (GB)

(72) Inventor: Gary Murphy, Widnes (GB)

(73) Assignee: THE LIVERPOOL RENEWABLE ENERGY RESEARCH CENTRE, Widnes (GB)

(21) Appl. No.: 14/007,180

(22) PCT Filed: Mar. 26, 2012
(86) PCT No.: PCT/GB2012/000275

§ 371 Date: Nov. 14, 2013

(30) Foreign Application Priority Data
Mar. 24, 2011 (GB) 1104931.9

(51) Int. Cl. H02K 7/02

(52) U.S. Cl. CPC H02K 7/025
USPC 74/572.11

(57) ABSTRACT

An energy storage system comprises a plurality of flywheels. Each flywheel has a receptacle comprising an outer wall and an inner wall, the inner and outer walls forming a cavity for receiving liquid when the flywheel is in use and wherein each of the plurality of flywheels is connected to common drive and/or driven means.

The present invention relates to an energy storage system and particularly flywheel energy storage systems and more particularly liquid fillable flywheel.

One of the major problems facing modern electrical generating and distribution equipment today is the inability of the equipment to be able to store large amounts of generated energy.

One of the main disadvantages of electrical energy generation, especially but not exclusively electrical energy generated from renewable energy sources, is that it is often possible to produce electricity at times when the demand for such electricity is low. On the other hand, when the demand for electricity is high, generating electricity from renewable energy sources is often not a viable option.

The term ‘renewable energy sources’ is often used to describe sources of energy that occur naturally in nature and do not for example require the burning of fossil fuels.

It is known to use flywheels as means for storing kinetic energy. However, the ability to store large amounts of kinetic energy requires extensive and expensive health and safety equipment. As a result, the cost of supplying the required safety equipment to flywheels for the storage of kinetic energy imposes severe limitations on the size of flywheel that may be utilised for the storage of kinetic energy with the result that the use of large solid flywheels is too costly and impractical.

For example, if a flywheel with a large mass were utilised such that in operation the flywheel revolved at a set speed, if damage either accidental or deliberate were to occur to the supporting structure holding the flywheel, such as the bearings or any other part supporting the flywheel, then the large amount of kinetic energy stored within the flywheel could cause considerable damage to property or even human life if the flywheel were to become detached from the support.

It is therefore desirable in the energy industry for there to be means for storing energy which is efficient, controllable, relatively inexpensive and safe. Moreover, it is desirable in the energy industry for there to be means for storing energy which can at least assist in meeting the demands of electricity distribution networks that is easy to use and provides means for at least substantially mitigating the safety concerns associated with current flywheel energy storage systems.

Accordingly, it is an object of the present invention to provide an energy storage system which is relatively inexpensive and safe.

It is also an object of the present invention to provide energy storage means capable of accommodating the differing energy requirements of energy distribution such that energy can be stored at times when the output from electrical generation is surplus to requirements and made available to be fed back into the electricity distribution system when required.

It is also an object of the present invention to provide means for monitoring the stored energy with a view to creating a national energy storage supply, where energy may be stored at various geographical locations and a central computer controlled monitoring facility may determine where the energy is stored and where the energy is required.

According to the present invention there is provided an energy storage system comprising a plurality of flywheels, each flywheel having a receptacle comprising an outer wall and an inner wall, the inner and outer walls forming a cavity for receiving liquid when the flywheel is in use and wherein each of the plurality of flywheels is connected to common drive and/or driven means.

The plurality of flywheels are advantageously disposed such that they share a common longitudinal axis.

Each of the plurality of flywheels is advantageously independently controllable relative to the other of the plurality of flywheels.

The energy storage system may further comprise a containment vessel operable to house the plurality of flywheels.

Alternatively, the energy storage system may comprise a plurality of containment vessels, each containment vessel operable to house one of the flywheels.

The, or each, containment vessel may comprise a removable liquid-sealable lid.

The plurality of flywheels are advantageously supported by a supporting framework.

The plurality of flywheels are advantageously connected to the supporting framework by an intangible connection operable to support the flywheels without physical contact therewith.

The intangible connection preferably comprises magnetic connection means.

The plurality of flywheels may be connected to a single drive shaft.

The cavity may comprise sealing means operable to allow the passage of fluid into the cavity when the flywheel is in operation and the free draining of the fluid from the cavity when the flywheel achieves a predetermined rotational speed.

The sealing means may comprise a one-way valve.

The cavity may comprise one or more baffles.

The, or each, baffle may comprise one or more portals.

Each flywheel may be attached to a separate independent drive shaft.

The independent drive shaft may comprise a clutch or electro-magnetic coupling for controlled coupling of the respective flywheel to a generator or motor.

The energy storage system may comprise one or more fluid reservoirs for storing fluid outside the flywheels.

The energy storage system advantageously comprises a controller operable to control each of the plurality of flywheels independently.

The controller is advantageously operable to process signals received from a plurality of sensors.

The controller is advantageously operable to control the speed and mass of each flywheel.

The controller is advantageously operable to transmit operational data to a remote computer system.

The energy storage system may further comprise at least one of a turbine, motor and generator operably connected to the plurality of flywheels.

The energy storage system advantageously further comprises fluid feeding means comprising a shaped feeder having a sloping inner wall such that, in use, when the rotational speed of the feeder is increased, centrifugal force acts to force fluid, from a reservoir, up the sloping inner wall and into one or more flywheels and when the rotational force is decreased, the force of gravity acts on the fluid to return the fluid to the reservoir.

The shaped feeder is advantageously formed from the base of the respective flywheel.

The containment vessel is preferably at least substantially evacuated of air.

By connecting the energy storage apparatus of the present invention to the national electricity distribution network, the monitoring of the energy stored may enable the central computer controlled monitoring facility to determine where and when to feed energy back into the national electricity distribution network.

Electrical control panel.

The present invention relates to one or more flywheels, more specifically, a liquid filled variable inertia flywheels in which a central processing unit monitors and controls the speed and mass of the flywheel using transducers and valves. The flywheel of the present invention is particular suited to the field of energy storage, more specifically to the area of energy storage within electrical generating and distribution networks.

A plurality of flywheels may be housed in a containment vessel the containment vessel may be sealed with a lid. The flywheels may be attached to a supporting framework within the containment vessel. The flywheels are used to store and release kinetic energy. This energy is then used to provide a force to drive an electrical generator. An electrical control panel may control the system hereafter described.

The control panel is provided to process signals from a plurality of sensors within the present invention, a solid-state electronic circuit in combination with a dedicated central processing unit running a computer program may process the signals. Conditional outputs from the control panel which depend upon signals received from the sensors within the present invention, may be used to operate and control a plurality of devices within the present invention.

In accordance with the present invention there is provided a flywheel suitable for use with a fluid wherein the flywheel comprises a receptacle for receiving a said fluid, the receptacle comprising an outer wall and an inner wall the inner wall and outer wall forming a cavity for holding the said fluid when the flywheel is in use.

The cavity advantageously further comprises sealing means for allowing the passage of fluid into the cavity when the flywheel is in operation and the free draining of the fluid from the cavity and flywheel when the flywheel arrives at a predetermined rotational speed. The sealing means may comprise a one-way valve.

The receptacle is preferably substantially circular.

The cavity advantageously comprises baffles, which preferably comprise portals. The baffles may be adjustable. The adjustment of the baffles may change the surface area of the baffle that is in contact with the fluid within the flywheel.

The fluid may enter the flywheel by means of inlets disposed on the base of the flywheel. The inlets are advantageously disposed to introduce fluid into a channel within the supporting means the fluid may then travel through the channel and into the cavity of the flywheel.

The flywheel may be in close proximity to a reservoir for holding the said fluid for use within the flywheel.

The flywheel may be connected to at least one of a turbine, motor and generator. The flywheel may be powered by at least one of steam, wind and water.

The flywheel may comprise at least one of a solenoid and valve. The flywheel may comprise one or more transducers and may comprise one or more strain gauges.

The flywheel may send or receive signals from at least one of the transducers and strain gauges to the electrical control panel.

The flywheel is advantageously hollow and advantageously comprised of lightweight material.

The flywheel advantageously comprises supporting means.

The flywheel may be used in a fresh or marine environment for the storage of and transfer of energy from a wave source into electricity.

Also according to the present invention there is provided a method of storing energy comprising providing a flywheel having a receptacle for receiving and holding a fluid, providing means for introducing a said fluid into the receptacle, providing means for monitoring the rotational speed of the flywheel in use, driving the flywheel, monitoring the rotational speed of the flywheel and introducing the said fluid into the receptacle at a predetermined rotational speed of the flywheel.

As the fluid is fed into the flywheel, centrifugal forces cause the fluid to move to the outer walls of the flywheel. As more fluid is fed into the flywheel the amount of fluid collecting at the outer walls of the flywheel increases.

There also exists a means of securing the fluid at the outer edges of the flywheel such that the fluid is only released from the walls and allowed to flow back into a storage tank when it is determined that the speed of the flywheel is below a predetermined speed.

The predetermined speed is calculated to be sufficiently low such that almost all of the kinetic energy stored within the flywheel is transferred to an electrical generator and thereby transferred to an available electrical supply network for use by the consumer during use.

One of the main advantages associated with the flywheel of the present invention is that as the structure of the flywheel is hollow, the flywheel may be comprised of lightweight composite materials.

Also, in the event of structural defects being found to be associated with the flywheel, the liquid contained within the flywheel may be released with only a short distance to travel before a tank, bund or other means of containing the liquid, thereby dispersing the majority of the kinetic energy into a harmless form.

Flywheels within a Containment Vessel:

To overcome these problems the present invention proposes a system that may incorporate a plurality of variable inertia hollow flywheels, connected together by a common drive shaft. To reduce energy losses from the flywheel due to turbulence between the flywheel and the surrounding air, the flywheels and the associated equipment may be housed within a containment vessel that may be sealed with a removable lid.

In the event of structural failure the containment vessel may confine any dangerous moving parts.

A Plurality of Containment Vessels:

A containment vessel housing a plurality of variable inertia flywheels may be connected to a similar containment vessel housing more variable inertia flywheels. The drive shaft within one containment vessel may be connected to the drive shaft within another containment vessel to form a common drive shaft connecting all of the variable inertia flywheels contained within the connected containment vessels. In this way a plurality of flywheels may all be attached to a common drive shaft.

A means to supply and/or release energy to or from the flywheel drive shaft may be fitted externally to the containment vessel.

At any instant a single flywheel may be engaged with the drive shaft or a plurality of flywheels may be engaged with the drive shaft.

Energy may then be accumulated within the flywheels of the present invention, or alternatively energy may be retrieved from within the flywheels of the present invention.

The electrical control panel will determine the number of flywheels that are engaged with the drive shaft at any instant.

A means of connecting motors and/or generators to the drive shaft is provided. The means of connection may be external to the containment vessel and a connection made to the drive shaft when the lid of the containment vessel is open.

In another embodiment of the present invention the apparatus used to supply and remove energy to and from the flywheel drive shaft may also be housed within the sealed containment vessel.

Alternatively energy may be transferred into the flywheels separately by way of each flywheel having its own independent drive means. The independent drive means may be for example an electric motor attached to the flywheel by way of a clutch.

Furthermore energy may be transferred out of the flywheels separately by way of each flywheel having its own independent generation means. The independent generation means may be for example an electric generator attached to a flywheel by way of a clutch.

Flywheel Support Means:

The flywheels rotate supported by bearings the bearings are supported by a framework within the containment vessel. The framework may also act as a means of segregation within the containment vessel.

During the life cycle of the apparatus contained within the present invention dust may develop

Or an individual flywheel or the associated apparatus of an individual flywheel may become detached from its connected parts. In such a case the means of segregation may prevent debris from moving around within the containment vessel. Therefore if a flywheel becomes damaged then debris from one flywheel may not interfere with the operation of another flywheel within the connected containment vessels.

Removable Lid:

The containment vessel may have a removable lid attached. The lid may be opened and closed using valves, pistons and motors all controlled and operated by the electrical control panel.

To reduce turbulence between the flywheel and the air, the lid of the containment vessel may be closed and the air within the containment vessel may be evacuated.

When energy is to be transferred in to or out of the flywheels, the lid to the containment vessel may be opened and a connection made between the drive shaft and a means to supply or release energy to or from the flywheel drive shaft, this may be for example a generator or a motor.

Connection of Drive Shaft:

A means of connection to the flywheel drive shaft may be fitted externally to the containment vessel and a connection may be made between the flywheel drive shaft and the external drive mechanism when the containment vessel lid is open.

In another embodiment of the present invention the apparatus used to supply and remove energy to and from the flywheel drive shaft may also be housed within the sealed containment vessel.

Clutches:

Each flywheel may rotate freely and independently of the drive shaft. Connection of the flywheels to the drive shaft may be made by way of a clutch. The electrical control panel may control the timing and operation of each clutch.

Individual Generator and Motor

Each flywheel may be fitted with an individual means of removing energy from the flywheel, such as for example an electrical generator.

Each flywheel may be fitted with an individual drive means, such as for example an electric motor.

Fluid in and Out of Flywheel:

The fluid used to increase the inertia within each flywheel may be held in a common reservoir. Each flywheel may also have an individual reservoir attached to a support means at the base of each flywheel. Fluid may be transferred from the common reservoir to an individual reservoir attached to each flywheel as required and determined by the electrical control panel.

A means of transferring fluid from the individual reservoirs to the inside of each flywheel is provided. A scooping means may be used where a tube with a sloped inside is immersed into the fluid. The centrifugal forces acting upon the fluid within the tube cause the fluid to rise up the slope and thereby enter the interior of the hollow flywheel.

The controlled flow of the fluid to the individual reservoir is used as a means of controlling the flow of fluid to the interior of the flywheel.

Pump Attached to the Main Drive Shaft:

At the base of the flywheel drive shaft a pumping means may be attached which may move fluid from within the main reservoir to the individual reservoirs attached to each flywheel.

The pump may be attached to the drive shaft by a clutch; the clutch may be controlled by electrical signals from the main electrical control panel.

When it is determined by the electrical control panel to move fluid from the main reservoir to the flywheels individual reservoir the pumping means and the clutch may be activated by signals from the electrical control panel.

Control Valve:

A control valve may be operated by signals from the electrical control panel the operation of the control valve will determine which of a plurality of flywheel reservoirs the fluid is transferred to.

Control Valve 2:

A control valve may be attached between the main reservoir and the flywheels individual reservoir to control the rate of flow of fluid between the reservoirs. The control valve may be controlled by the electrical control panel, the adjustment of the control valve depending on signals received from sensors throughout the apparatus of the present invention. In this way the flow of fluid into each flywheel may be accurately controlled thereby controlling the moment of inertia if each flywheel within the system.

Sloped to allow fluid to flow from the edges to towards the centre of the flywheel

The base of the hollow flywheels may be sloped to enable fluid within the flywheel to flow freely towards the centre of the flywheel when the speed of rotation is reduced sufficiently to allow the weight of fluid to act against the centrifugal forces.

The hollow flywheel may be fitted with holes to allow fluid to flow from the interior of the flywheel to the individual fluid reservoir attached to each flywheel. Thereby allowing the fluid to flow from the flywheel if there are very few rotational forces applied. The fluid may then return to the main fluid reservoir by way of the connecting means provided such as tubes or pipes.

Sloped to allow fluid to flow from the edges to towards the centre of the flywheel

The base of the hollow flywheels may be sloped to enable fluid within the flywheel to flow freely towards the centre of the flywheel when the speed of rotation is reduced sufficiently to allow the weight of fluid to act against the centrifugal forces.

The hollow flywheel may be fitted with holes to allow fluid to flow from the interior of the flywheel to the individual fluid reservoir attached to each flywheel. Thereby allowing the fluid to flow from the flywheel if there are very few rotational forces applied. The fluid may then return to the main fluid reservoir by way of the connecting means provided such as tubes or pipes.

Pump and Reservoir Fitted Externally of the Sealed Vessel

In another embodiment, to improve maintenance procedures the pumping means and/or the main system reservoir may be attached to the apparatus but situated externally of the sealed containment vessel. The pumping means may be used to transfer fluid from the system reservoir to the individual flywheel reservoir. Connecting means such as for example pipes may be attached to the external pump to enable the transfer of fluid into the containment vessel.

Pressure Release Apparatus:

Under normal operating conditions. To reduce the losses that would occur due to the turbulence created by the rotation of the flywheels, the main containment vessel will have a quantity of the air evacuated.

Under fault conditions, such as structural failure the fluid may be expelled from the rotating flywheels in a short time interval, the kinetic energy stored within the rotating parts and the rotating fluid may course a rise in temperature within the sealed containment vessel.

In the event of any build up in pressure within the sealed containment vessel, and to avoid the possibility of an explosion and the subsequent health and safety risks a means of pressure release is attached, to allow for the instant release of any such pressure

Pressure Release Apparatus:

Under normal operating conditions. To reduce the losses that would occur due to the turbulence created by the rotation of the flywheels, the main containment vessel will have a quantity of the air evacuated.

Under fault conditions, such as structural failure the fluid may be expelled from the rotating flywheels in a short time interval, the kinetic energy stored within the rotating parts and the rotating fluid may course a rise in temperature within the sealed containment vessel.

In the event of any build up in pressure within the sealed containment vessel, and to avoid the possibility of an explosion and the subsequent health and safety risks a means of pressure release is attached, to allow for the instant release of any such pressure

For a better understanding of the present invention and to show more clearly how it may be carried into effect, the invention will now be described further with reference made by way of example only, to the accompanying drawings, in which:

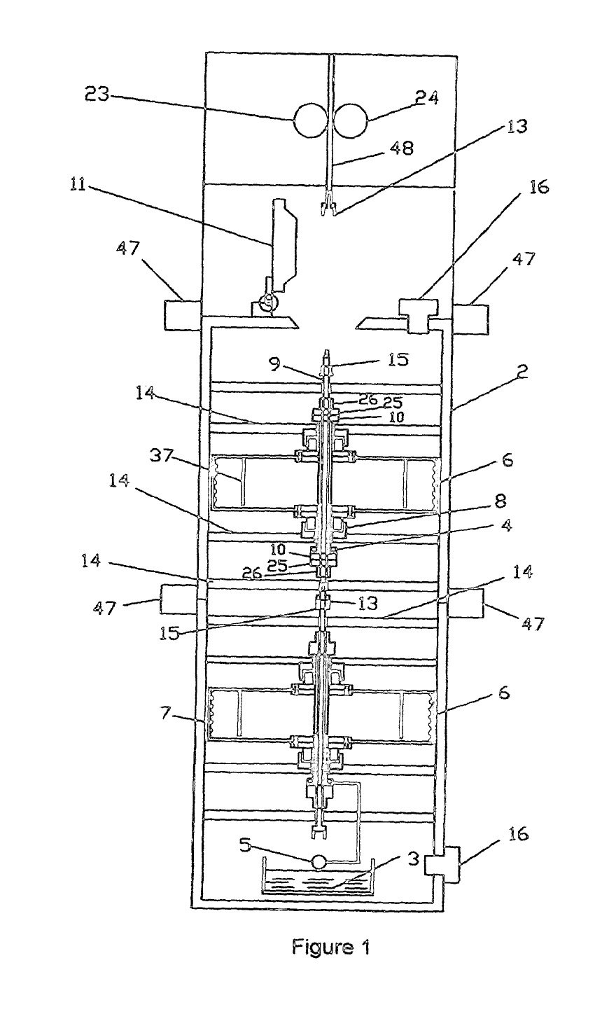

FIG. 1 shows how two containment vessel each containing a single flywheel may be connected together;

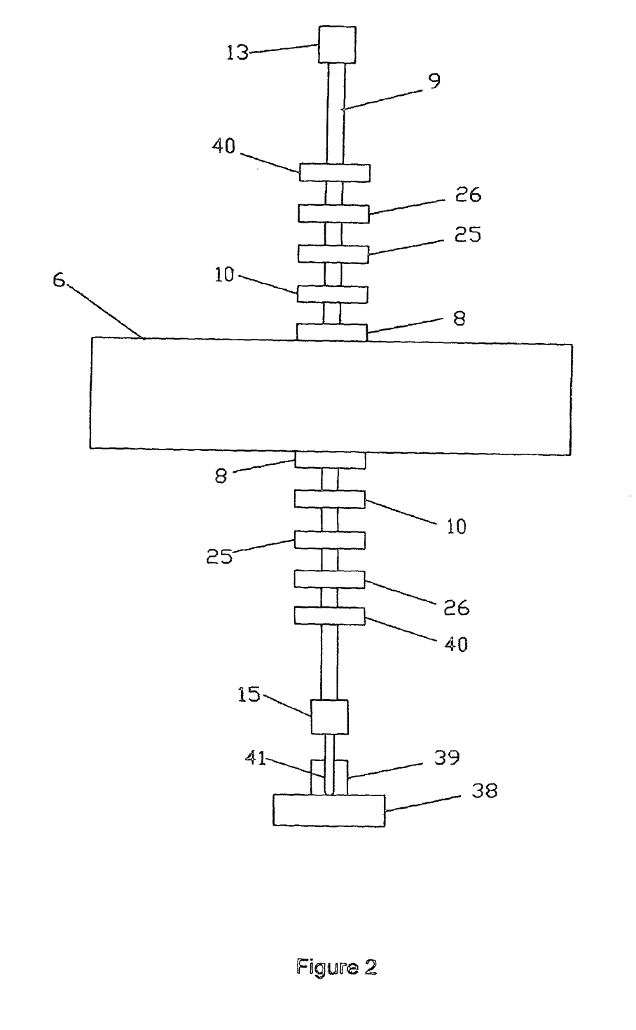

FIG. 2 shows how the drive shaft may be connected to the flywheel, bearings, clutches and other associated apparatus;

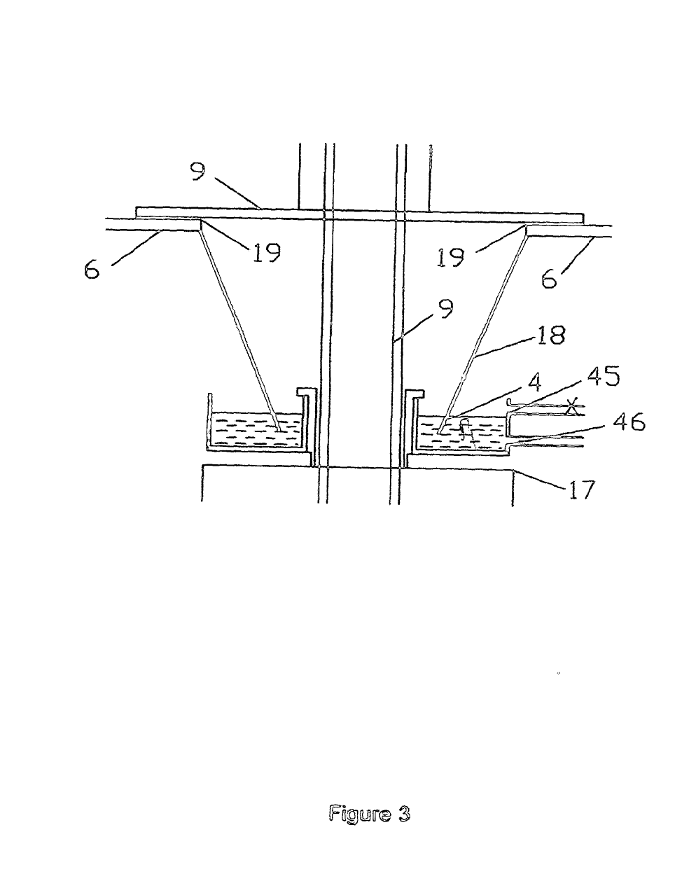

FIG. 3 shows how a fluid reservoir may be attached to a flywheel;

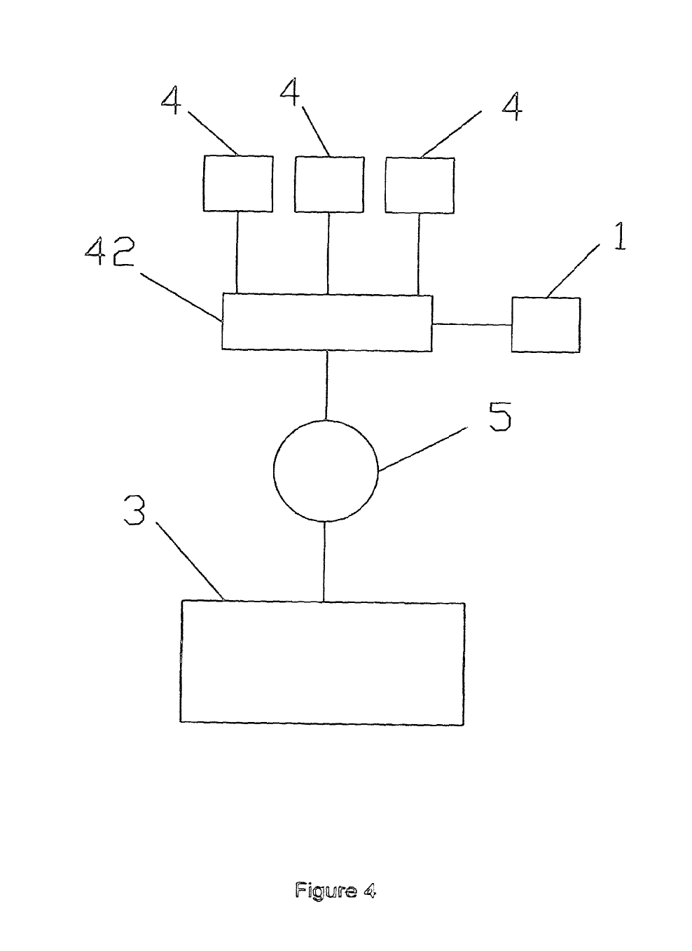

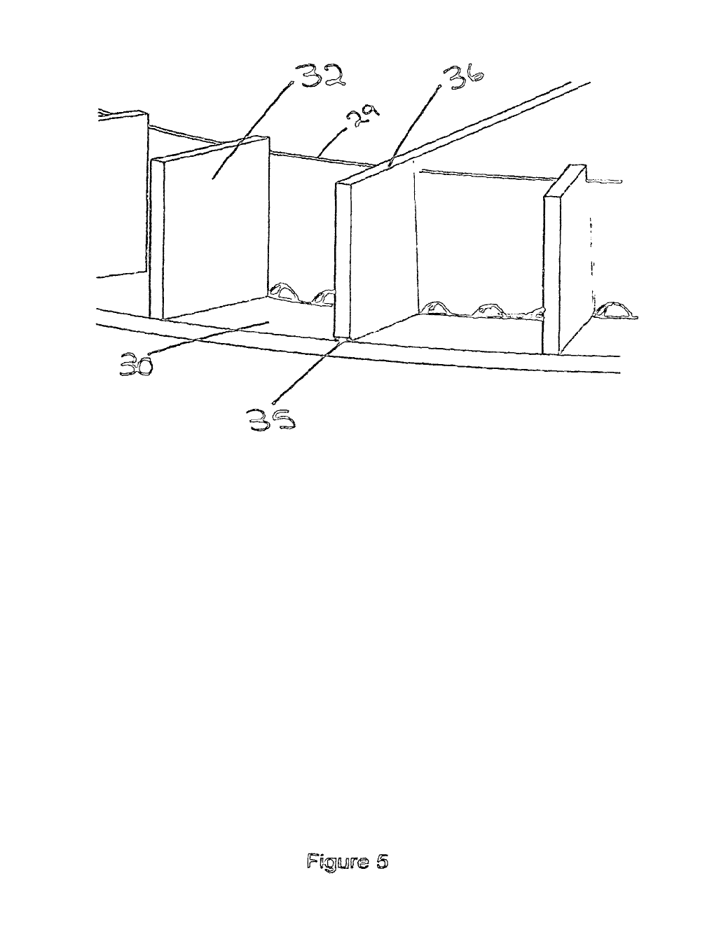

FIG. 4 shows how a control valve may be used to distribute fluid to a plurality of Flywheels;

FIG. 5 shows how a channel may be used to deliver fluid to the outer edges of a flywheel; and

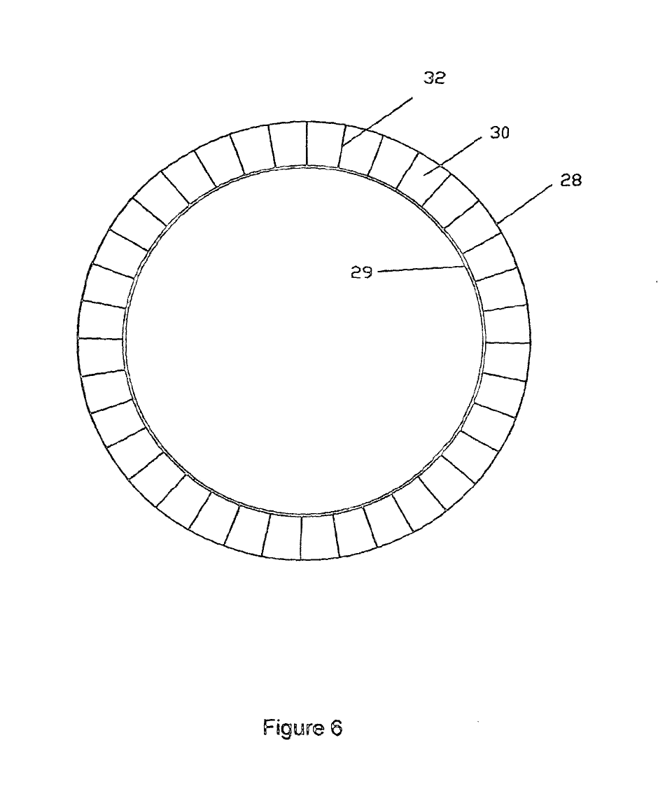

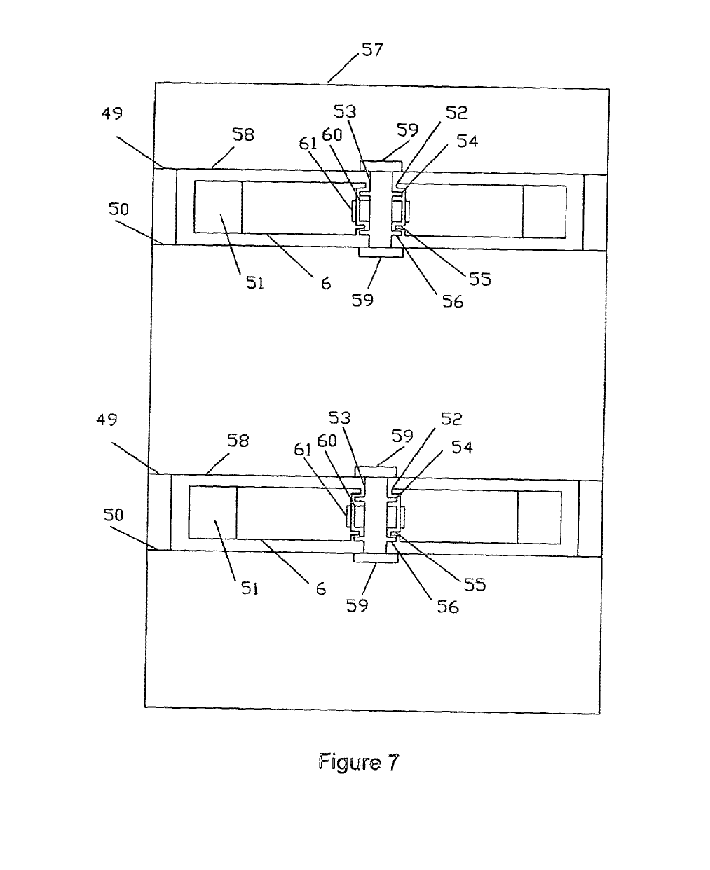

FIG. 6 shows how baffles may be distributed around the outer edge of a flywheel.

### DETAILED DESCRIPTION

FIG. 1, shows how one or more flywheels 6, may be supported by a supporting framework 14, within a containment vessel 2, the containment vessel 2, may be attached to another containment vessel 2, by the attachment means 47.

The containment vessel may be sealed and may have a removable lid 11, attached.

When the lid 11, of the containment vessel 2, is closed the majority of the air within the containment vessel 2, may be removed using a vacuum pump. (Not shown)

A pressure release means 16, may be fitted to enable any build up of pressure within the containment to be safely release at a predetermined pressure.

The flywheel 6, rotates on a drive shaft 9. The drive shaft 9, may be connected to another drive shaft 9, within a connected containment vessel. Thereby connecting a plurality of flywheels 9, byway of a common drive shaft 9.

The flywheels 6, may be attached to the drive shaft 9, by one or more bearings 8. The bearings 8, may support the drive shaft 9. A support means 14, is provide to support the bearings 8.

A drive means 24, may be provided to apply a rotational force to the drive shaft 9. The drive means 24, may be attached externally of the containment vessel 2, the drive means 24,may be connected to an external drive shaft 48, The external drive shaft 48, may be connected to the flywheel drive shaft 9 when the lid 11 is open A coupling means 13 is provided to enable the drive shaft 48, to connect with drive shaft 9. When the drive shaft 48, is connected to drive shaft 9, the external drive means 24 may be used to transfer rotational forces to the flywheel 6.

A drive means 26, to apply a rotational force to the drive shaft 9, may be attached to the drive shaft 9, within the sealed containment vessel 2.

The drive means 26, connected to the drive shaft 9, within the sealed containment vessel 2, may contain a turbine, which may be driven by fluid under pressure, connected to a fluid pressure supply attached externally to the sealed containment vessel.

The fluid pressure supply may be a pump driven by a drive means.

The energy transfer means 24, for removing the energy from the drive shaft 9,may be attached externally to the containment vessel 2, and the energy transfer means 24, may be attached to the drive shaft 9, when the lid of the containment vessel 2, is open.

The energy transfer means 25, for removing energy from the drive shaft 9, may be attached to the drive shaft 9, within the sealed containment vessel 2.

The energy transfer means connected to the drive shaft within the sealed containment vessel may pump fluid under pressure through a connecting means to a turbo-generator attached to the connecting means but situated outside of the containment vessel.

A main reservoir 3, containing the fluid that is supplied to each flywheel 6, within the present invention may be attached to the containment vessel 2.

The reservoir 3, may be attached within the sealed containment vessel 2.

In another embodiment the reservoir 3, may be attached externally to the containment vessel 2, and fluid may travel into the containment vessel 2, through a connecting means such as for example pipes.

Each flywheel 6, may have an individual reservoir 4, attached to the flywheel 6. A supporting means 14, may be attached to framework to support the reservoir 4.

When the control system within the electrical control panel 1, determines the correct time to activate the pumping means 3, fluid may be transferred under pressure from the main reservoir 3, to the appropriate individual flywheel reservoir 4.

FIG. 3, shows how when fluid is present within the flywheel reservoir 4, the rotational speed of the flywheel 6, which is attached to the feed tube 18, will cause the centrifugal forces acting upon the fluid within the feed tube 18, to force the fluid up the wall of the feed tube 18, and into the hollow flywheel 6, through apertures 19, located at the base of the flywheel 6. The centrifugal forces acting within the flywheel 6, will force the fluid to move to the outer edges of the flywheel 6, and enter the cavity 30. The electrical control panel 1, will determine the amount of fluid that enters the flywheel 6, and this will depend upon the energy available and the amount of energy that con be stored. This is calculated using the speed and mass of the flywheel 6 which is constantly being measured by transducers within the system (Not shown)

When the energy has been transferred from the flywheel 6, to the generating means and the speed of the flywheel 6, has been reduced, the fluid from within the flywheel 6, will fall towards the base of the flywheel 6. The base of the flywheel 6, may be shaped on an incline towards the centre of the flywheel 6. The fluid may flow towards the centre of the flywheel 6, and flow out of the flywheel through a plurality of holes 19, and into the reservoir 4. The fluid may then flow through the connecting means in to the main reservoir 3.

The flywheels 6, and drive shaft 9, may levitate on magnetic bearings 8. When the flywheels 6, are filled with fluid the weight of the fluid may force the drive shaft 9, down due to the forces of gravity. To prevent friction between the moving parts of the magnetic bearings 8, a lower means of support 41, may be provided this may be situated at the bottom of the drive shaft 9.

When the weight of the fluid within the flywheels 6, connected to the drive shaft 9, is so great that the drive shaft 9, pushes down, a bearing pin 41, may then be forced to connect to a bearing block 38, to create a physical connection which may prevent the drive shaft 9 from travelling any further. The bearing block 38, may have shock absorbers attached (Not Shown)

The shock absorbers may be adjustable and controlled by the electrical control panel.

The flywheels rotate supported by bearings 8, the bearings are supported by a framework 14, within the containment vessel 2. The framework 14, may also act as a means of segregation within the containment vessel 2.

During the life cycle of the apparatus contained within the present invention dust may develop

or an individual flywheel 6, or the associated apparatus of an individual flywheel 6, may become detached from its connected parts. In such a case the means of segregation 14, may prevent debris from moving around within the containment vessel 2. Therefore if a flywheel 6, becomes damaged then debris from one flywheel 6, may not interfere with the operation of another flywheel 6, within the connected containment vessels 2.

1. An energy storage system comprising a plurality of flywheels, each flywheel having a receptacle comprising an outer wall and an inner wall, the inner and outer walls forming a cavity for receiving liquid when the flywheel is in use and wherein each of the plurality of flywheels is connected to common drive and/or driven means.

2. The energy storage system of claim 1, wherein the plurality of flywheels are disposed such that they share a common longitudinal axis.

3. The energy storage system of claim 1, wherein each of the plurality of flywheels is independently controllable relative to the other of the plurality of flywheels.

4. The energy storage system of claim 1, comprising a containment vessel operable to house the plurality of flywheels.

5. The energy storage system of claim 1, comprising a plurality of containment vessels, each containment vessel operable to house one of the flywheels.

6. The energy storage system of claim 4, wherein the, or each, containment vessel comprises a removable liquid sealable lid.

7. The energy storage system of claim 1, wherein the flywheels are supported by a supporting framework.

8. The energy storage system of claim 8, wherein the flywheels are connected to the supporting framework by an intangible connection operable to support the flywheels without physical contact therewith.

9. The energy storage system of claim 8, wherein the intangible connection comprises magnetic connection means.

10. The energy storage system of claim 1, wherein the plurality of flywheels are connected to a single drive shaft.

11. The energy storage system of claim 1, wherein the cavity comprises sealing means operable to allow the passage of fluid into the cavity when the flywheel is in operation and the free draining of the fluid from the cavity when the flywheel achieves a predetermined rotational speed.

12. The energy storage system of claim 11, wherein the sealing means comprises a one-way valve.

13. The energy storage system of claim 1, wherein the cavity comprises one or more baffles.

14. The energy storage system of claim 13, wherein the, or each, baffle comprises one or more portals.

15. The energy storage system of claim 1, wherein each flywheel is attached to a separate independent drive shaft.

16. The energy storage system of claim 15, wherein the independent drive shaft comprises a clutch or electro-magnetic coupling for controlled coupling of the respective flywheel to a generator or motor.

17. The energy storage system of claim 1, comprising one or more fluid reservoirs for storing fluid outside the flywheels.

18. The energy storage system of claim 1, further comprising a controller operable to control each of the plurality of flywheels independently.

19. The energy storage system of claim 18, wherein the controller is operable to process signals received from a plurality of sensors.

20. The energy storage system of claim 18, wherein the controller is operable to control the speed and mass of each flywheel.

21. The energy storage system of claim 18, wherein the controller is operable to transmit operational data to a remote computer system.

22. The energy storage system of claim 1, further comprising at least one of a turbine, motor and generator operably connected to the plurality of flywheels.

23. The energy storage system of claim 1 further comprising fluid feeding means comprising a shaped feeder having a sloping inner wall operable to cause centrifugal force to force fluid, from a reservoir, up the sloping inner wall and into one or more flywheels when the rotational speed of the feeder is increased, and when the rotational force is decreased, to cause the force of gravity to act on the fluid to return the fluid to the reservoir.

24. The energy storage system, of claim 23, wherein the shaped feeder is formed from the base of the respective flywheel.

25. The energy storage system of claim 1, wherein the containment vessel is at least substantially evacuated of air.

26. The energy storage system of claim 1, further comprising a pressure release mechanism.
